(19) United States
(12) Patent Application Publication
(10) Pub. No.: US 2005/0240972 A1
(43) Pub. Date: Oct. 27, 2005

(54) Method of processing subscriber contract information (WLAN)

(75) Inventors: Wenlin Zhang, Guangdong (CN); Zhiming Li, Guangdong (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Guangdong (CN)

(21) Appl. No.: 11/122,297

(22) Filed: May 4, 2005

Related U.S. Application Data
(63) Continuation of application No. PCT/CN03/00902, filed on Oct. 27, 2003.

(30) Foreign Application Priority Data
Nov. 8, 2002 (CN) 02148903.3

(51) Int. Cl. H04N 7/18; G06F 13/00; H04N 5/445; G06F 3/00

(52) U.S. Cl. 725/81; 725/80; 725/74

(57) ABSTRACT

A method for processing subscription information in a Wireless Local Area Network (WLAN), applicable to a WLAN interactive network mainly composed of WLAN user terminals, a WLAN access unit, a subscription information application unit and a subscription information storage unit, including the following steps: when the subscription information of a user terminal stored in the subscription information application unit is to be deleted, the subscription information application unit determining whether the deletion is instructed by the subscription information storage unit; if so, deleting the subscription information according to the instruction and ending the procedure; otherwise, sending a notification of purging the WLAN subscriber relevant information to the subscription information storage unit after deleting the subscription information; after receiving the notification, the subscription information storage unit recording the notified information. With this method, the subscription information storage unit can acquire in time the information of the deletion of the subscription information so as to avoid sending redundant messages and improve the working efficiency of the system.

### CROSS-REFERENCE TO RELATED APPLICATION

This is a continuation of copending international application PCT/CN2003/000902 filed Oct. 27, 2003, the entire disclosure of which is incorporated herein by reference.

### BACKGROUND OF THE INVENTION

1. Field of the Invention

The invention relates to processing of subscription information, in particular, to a method for deleting subscription information in a subscription information application unit of a Wireless Local Area Network (WLAN).

2. Related Technology

As users demand higher and higher wireless access speed, WLANs have emerged to provide high-speed wireless data access in small areas. There are many different technologies used for WLANs, and a standard with wider application at present is IEEE 802.11b, which runs at 2.4 GHz frequency band. Another technology at the same frequency band is Bluetooth. Other new technologies, such as IEEE 802.11a and ETSI BRAN Hiperlan2, adopt 5 GHz frequency band.

Despite many different wireless access technologies, most WLANs are used to transfer Internet Protocol (IP) data packet. For a wireless IP network, the specific WLAN access technologies are usually transparent to upper IP layer and the basic concept is to achieve wireless access for user terminals by means of an Access Point (AP) and to construct an IP transmission network by network control and link of connection devices.

For wireless networks, there is always a PURGE mechanism between a Visitor Location Register (VLR) and a Home Location Register (HLR) in a Global System for Mobile communication (GSM), or between a Serving GPRS Support Node (SGSN) and a Home Location Register (HLR), so as to ensure that a notification will be sent to the HLR after the subscriber relevant information stored in the VLR or the SGSN has been deleted.

With the rising and development of WLANs, the inter-working between WLANs and various wireless mobile communication networks, such as GSM, Code Division Multiple Access (CDMA) system, Wideband Code Division Multiple Access (WCDMA) system, Time Division-Synchronous Code Division Multiple Access (TD-SCDMA) system and CDMA 2000 system, is becoming the focus of current research. According to the provisions of the Third Generation Partnership Project (3GPP) standardization organization, the simplified network architecture for inter-working between WLANs and 3GPP systems is shown in FIG. 1. User terminals can access to the Internet and Intranet as well as to the core network of a 3GPP system via a WLAN access network. Obviously, as a wireless access technology for providing IP communications, WLANs are able to connect and interact with many other networks.

When a WLAN is connected with another network, authentication, authorization and accounting for the connection is usually controlled and handled by a corresponding server, and the subscription information is managed in a subscription information storage unit, e.g. a Home Subscriber Server (HSS)/HLR in a 3GPP system. When authentication, authorization and accounting is needed, the subscription information is obtained from the subscription information storage unit by a corresponding application server, such as an Authentication, Authorization and Accounting (AAA) server, for storage until the user terminates the service. When the subscription information is changed in the subscription information storage unit, this subscription information storage unit will notify the corresponding application server to update the data in time. When the user terminates the service and the subscription information is not needed any longer, the subscription information application server can delete the relevant data of the user. In implementation, it is possible to delete the relevant data of the user immediately after he is offline or to keep the data for a period of time before it is deleted so that it can be used when the user logs in again.

When the subscription information is deleted in the corresponding application server, the subscription information storage unit should be notified at the meantime to avoid the storage unit from sending unnecessary interactive signaling. However, no mechanism for this purpose has so far been proposed for WLAN systems, that is to say, there has been so far no procedure defined for notifying the subscription information storage unit after the information in the subscription information application server is deleted. As a result, the subscription information storage unit does not know which subscription information has been deleted, and will still send unnecessary commands to the subscription information application server when the information needs to be updated or deleted, consequently leading to waste of system resources. Furthermore, when this kind of signaling is of a great amount, the system's normal running will be affected.

### SUMMARY OF THE INVENTION

In view of the foregoing, it is desirable to provide a method for processing subscription information in a WLAN, enabling the subscription information storage unit to acquire in time the information that the subscription information has been deleted so as to avoid sending redundant messages and improve the working efficiency of the system.

For the above purpose, the following solution is provided according to the invention.

A method for processing subscription information in a WLAN, applicable to a WLAN interactive network mainly composed of WLAN user terminals, a WLAN access unit, a subscription information application unit and a subscription information storage unit, the method including the steps of:
a. when the subscription information of a user terminal stored in the subscription information application unit is to be deleted, the subscription information application unit determining whether the deletion is instructed by the subscription information storage unit, if so, deleting the subscription information according to the instruction and ending the procedure; otherwise, sending a notification of purging the WLAN subscriber relevant information to the subscription information storage unit after deleting the subscription information;
b. after receiving the notification, the subscription information storage unit recording the notified information. Here, the step of recording the notified information in step b comprises setting a record or an indicator to indicate that the WLAN subscription information has been deleted in the corresponding subscription information application unit.

The subscription information application unit is preferably an AAA server. In a 3G system, the AAA server is a 3GPP AAA Server. The subscription information storage unit is preferably a HSS or a HLR.

The method may further include the steps of: after implementing a processing for the deleted subscription information, the subscription information storage unit returns a response message to the subscription information application unit.

The deletion of the subscription information of a user terminal in step a is preferably implemented in the subscription information application unit immediately after the user terminal is disconnected from the WLAN network. Alternatively, the deletion of the subscription information of a user terminal in step a may be implemented after the subscription information of the user terminal has been kept in the application unit for a period of time since the user terminal was disconnected from the WLAN network.

Therefore, with the inventive method for processing the subscription information in a WLAN, a message may be sent in time to notify the subscription information storage unit after the subscription information is deleted by the subscription information application unit, so that the subscription information storage unit will no longer send redundant updating or deleting messages. Therefore, unnecessary consumption of system resources is avoided; the working efficiency of the system and the effectiveness of message transmission are improved; and more convenient and diversified services for WLAN users can be provided.

### BRIEF DESCRIPTION OF THE DRAWINGS

FIG. 1 is a schematic diagram illustrating the simplified network architecture for the inter-working between a WLAN and a 3GPP system.

FIG. 2 is a schematic diagram illustrating the network architecture for the subscription information management in a WLAN system.

FIG. 3 is a signaling procedure of the method according to the invention.

FIG. 4 is a schematic diagram illustrating the network architecture according to an embodiment of the invention.

FIG. 5 is a signaling flowchart of the method according to an embodiment of the invention.

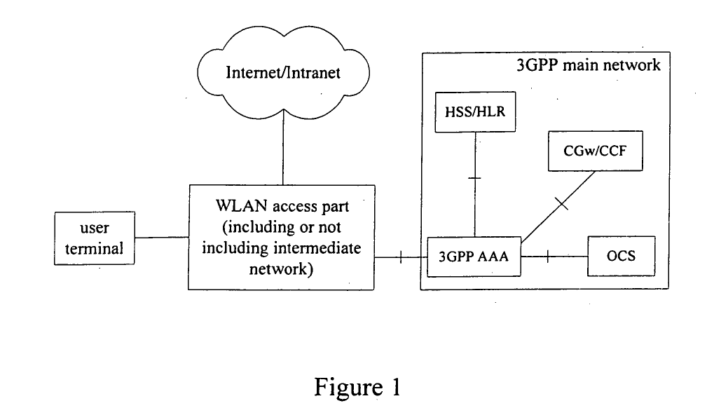

### DETAILED DESCRIPTION OF THE INVENTION

The invention will be further described in detail hereinafter with reference to the accompanying drawings and a specific embodiment.

In view of the prior art of WLAN, an interactive method between a subscription information application unit and a subscription information storage unit in a WLAN system is proposed herein. In this method, the subscription information application unit will send a notification to the subscription information storage unit immediately after the subscription information in the subscription information application unit is deleted.

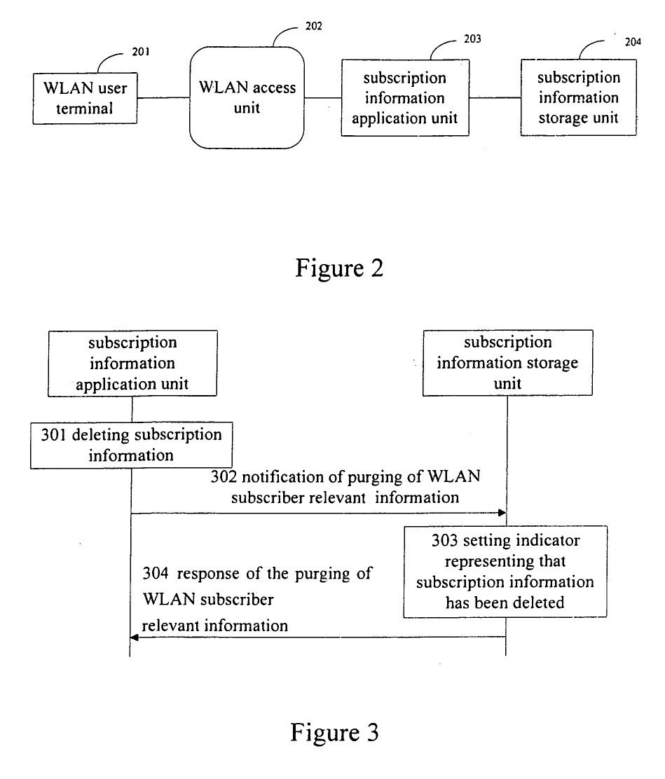

As shown in FIG. 2, which is a schematic diagram illustrating the network architecture for implementing subscription information management in a WLAN system, a WLAN access unit 202 is responsible for user terminals' access and routing management, making the user terminals be able to communicate with one another through IP protocol and to connect and communicate with other IP networks. Usually, the WLAN access unit mainly includes an Access Point (AP) and an Access Controller (AC), and may also include a router for network connection and a relevant server for network control, etc. A subscription information application unit 203 is mainly responsible for subscription information management, making a decision based on subscription information and controls network access and the provisioning of services when a user is accessing or using a certain service. AAAA server is a specific example of the subscription information application unit. The subscription information storage unit 204 is used to store subscription information of all users.

In general, after a WLAN user terminal 201 has accessed to the WLAN for the first time via the WLAN access unit 202, the subscription information is stored in both the subscription information application unit 203 and the subscription information storage unit 204. When this WLAN user terminal needs this subscription information for accessing networks again or accessing relevant services, the subscription information application unit 203 will search the information in itself. If the subscription information is not found, the subscription information application unit 203 will obtain the information from the subscription information storage unit 204, such as the HSS/HLR, and store the obtained information. When the subscription information is deleted by and from the subscription information application unit 203, if it is not deleted as instructed by the subscription information storage unit 204, the subscription information application unit 203 will send a message to the subscription information storage unit 204, notifying the storage unit 204 that relevant information of a certain user terminal has been deleted.

The procedure by which the subscription information application unit notifies the subscription information storage unit of the deletion of the subscription information is shown in FIG. 3, comprising the steps as follows.

In Steps 301˜302, when subscription information of a certain user terminal is to be deleted in the subscription information application unit, the subscription information application unit determines whether the deletion is instructed by the subscription information storage unit; if so, it will delete this subscription information according to the instruction of the storage unit and end this procedure; otherwise, it will send a notification to the subscription information storage unit right after it deletes the data, notifying the subscription information storage unit to purge the WLAN subscriber relevant information.

In Step 303, the subscription information storage unit records the notified information after receiving the notification. In specific applications, said recording of the notification may comprise setting a record or an indicator to indicate that the WLAN subscription information has been deleted in the corresponding subscription information application unit so that it is convenient for the user to re-use the information when he logs in again.

The subscription information storage unit, after implementing a processing for the deleted subscription information, may further implement a step 304 in which the subscription information storage unit sends to the application unit a response message for the purging of the WLAN subscriber relevant information, indicating that the information has been correctly recorded.

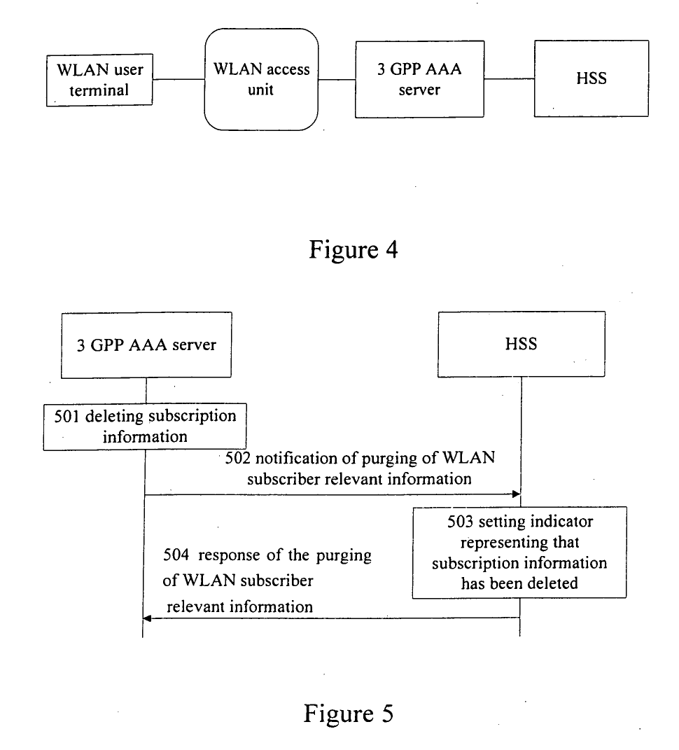

FIG. 4 and FIG. 5 respectively illustrate the network architecture and the signaling flowchart according to a specific embodiment of the present invention. As shown in FIG. 4, this embodiment is implemented in the inter-working between a 3GPP network and a WLAN. In this embodiment, the subscription information application unit is a 3GPP AAA Server in charge of authentication, authorization and accounting for users; the subscription information storage unit is an HSS in charge of storing the subscription information. As a result, this 3GPP-WLAN interactive service network comprises WLAN user terminals, a WLAN wireless access unit, a 3GPP AAA Server and an HSS, and is connected to the packet field in the 3GPP network as well as to the Internet.

When a user terminal logs in the 3GPP-WLAN interactive service network and receives a service, the subscription information of the user is downloaded to the 3GPP AAA Server from the HSS. The downloaded data will be deleted sometime later, for example, when the user logs out from the system and exits the WLAN, when the user has exited the WLAN for some time, when the system needs to delete the data due to reasons in operation and maintenance, or when the administrator of the 3GPP AAA Server has to delete the data of a user with reasons such as in management. In all these cases, the 3GPP AAA Server should notify the HSS after the data is deleted.

Based on the network architecture as shown in FIG. 4, the process by which the 3GPP AAA Server notifies the HSS of the deletion of the subscription information in this exemplary embodiment is shown in FIG. 5, comprising the steps as follows.

In Steps 501˜502, when subscription information of a certain user terminal is to be deleted in the 3GPP AAA Server, the 3GPP AAA Server determines whether the deletion is instructed by the HSS; if so, it will delete this subscription information according to the instruction of the HSS, return a response message to the HSS according to specific requirements of the implementation, and end this procedure; otherwise, it will send a notification to the HSS right after it deletes the data, notifying the HSS to purge the WLAN subscriber relevant information.

In Step 503, the HSS records the notified information after receiving the notification. In specific applications, said recording the notification may comprise setting a record or an indicator as required to indicate that the WLAN subscription information has been deleted in the corresponding subscription information application unit so that it is convenient for the user to re-use the information when he logs in again.

The HSS, after implementing a processing for the deleted subscription information, may further implement Step 504 in which the HSS sends to the 3GPP AAA Server a response message for the purging of the WLAN subscriber relevant information, indicating that the information about purge has been correctly recorded.

In the above process, transmission of the notification and response between the 3GPP AAA Server and the HSS about the purging of the WLAN subscriber relevant information is implemented by means of existing protocols, such as Mobile Application Part (MAP) protocol, Remote Authentication Dial-In User Service (RADIUS) protocol, or Diameter protocol, etc.

The above description is just a preferable embodiment of the invention and not to be construed to limit the scope thereof.

1. A method for processing subscription information in a Wireless Local Area Network (WLAN), applicable to a WLAN interactive network comprising WLAN user terminals, a WLAN access unit, a subscription information application unit and a subscription information storage unit, said method comprising the following steps:
a. when subscription information of a user terminal stored in the subscription information application unit is to be deleted, the subscription information application unit determining whether the deletion is instructed by the subscription information storage unit; if so, deleting the subscription information according to the instruction and ending the procedure, otherwise, sending a notification of purging the WLAN subscriber relevant information to the subscription information storage unit after deleting the subscription information; and
b. after receiving the notification, the subscription information storage unit recording the notified information.

2. The method according to claim 1, further comprising: after implementing a processing for the deleted subscription information, the subscription information storage unit returning a response message to the subscription information application unit.

3. The method according to claim 1, wherein said subscription information application unit is an Authentication, Authorization and Accounting (AAA) server.

4. The method according to claim 3, wherein said AAA server is a Third Generation Partnership Project (3GPP) AAA Server.

5. The method according to claim 1, wherein said subscription information storage unit is a Home Subscriber Server (HSS) or a Home Location Register (HLR).

6. The method according to claim 1, wherein said step of recording the notified information in step b comprises setting a record or an indicator to indicate that the WLAN subscription information has been deleted in the corresponding subscription information application unit.

7. The method according to claim 1, wherein said deletion of the subscription information in step a is implemented in the subscription information application unit immediately after the user terminal is disconnected from the WLAN network.

8. The method according to claim 1, wherein said deletion of the subscription information in step a is implemented after the subscription information of the user terminal has been kept in the application unit for a period of time since the user terminal was disconnected from the WLAN network.
